(19) United States
(12) Patent Application Publication
(10) Pub. No.: US 2009/0318578 A1
(43) Pub. Date: Dec. 24, 2009

(54) HYBRID CATIONIC CURABLE COATINGS

(75) Inventors: Dennis John Versteeg, Nuenen (NL); Anne Ference Karel Victor Biezemans, Oss (NL)

Correspondence Address: DICKSTEIN SHAPIRO LLP, 1633 Broadway, NEW YORK, NY, 10019, US

(73) Assignee: Eques Coatings, Oss (NL)

(21) Appl. No.: 12/516,026

(22) PCT Filed: Nov. 23, 2007
(86) PCT No.: PCT/EP07/10730

§ 371 Date: Aug. 19, 2009

(30) Foreign Application Priority Data
Nov. 23, 2006 (GB) 0623414.0

(51) Int. Cl. C08F 2/46

(52) U.S. Cl. 522/31; 522/170; 522/79

(57) ABSTRACT

An ultraviolet-curable resin composition comprises: (A) at least one silane having a hydrolysable group and at least one group containing a cyclic ether; (B) at least one material containing one or more cyclic ether groups, which is not an alkoxysilane and is different from the silane (A); (C) a cationic photoinitiator; (D) optionally an organic solvent, such as propylene carbonate; and (E) optionally other conventional additives.

The present invention relates to energy, e.g. ultraviolet, curable hybrid organic-inorganic coatings that combine the cationic cure capability of cyclic ethers and other cationic curing materials with the cationic induced hydrolysis and subsequent condensation typical of alkoxysilanes.

Ultraviolet curable coatings are of ever-increasing importance in the coatings industry. The combination of solvent-free materials and fast curing is attractive for many industrial applications.

The most commonly used type of ultraviolet curable coating is based on free-radical photoinitiation and (meth)acrylates. Its value is based on its nearly instantaneous curing at room temperature, the absence of solvents, the wide choice of raw materials and the large possibilities to tune coating properties and performance with these. However, inhibition by oxygen, large shrinkage and difficulty to cure three-dimensional or shadowed areas are drawbacks of the use of free-radical based chemistry that are sometimes encountered.

Ultraviolet curable coatings based on cationic photoinitiation are often used when these drawbacks become difficult to overcome. Generally, cationically photoinitiated materials show a smaller shrinkage on curing, are not inhibited by oxygen and, due to a dark-cure or post-cure effect, shadowed areas or three-dimensional substrates can also be cured. Drawbacks to the use of these materials generally include inhibition by bases and slower curing speeds.

Cationic photoinitiators are usually of the type of the so-called onium salts (such as diazonium, iodonium and sulphonium salts). Also, metallocenium salts (such as ferrocenium salts) can be used. The onium salts are positively charged, usually with a value of +1, and a negatively charged counterion is present. These counterions are usually bonded fluorides, such as BF₄⁻, PF₆⁻, SbF₆⁻, AsF₆⁻, and others, because they are extremely weak bases, resulting, after dissociation of the onium group, in very strong or super-acids that are extremely effective in initiating polymerisation of the receptive network-forming molecules.

Traditionally, cyclic ethers are the most commonly used receptive species. Cyclic ethers with small rings, such as an epoxy or oxetane group, have a high ring tension and the ring can be opened by an acid, forming a cationic species that can further react with other cyclic ethers to form a polymer network.

The most commonly used cyclic ethers in cationic polymerisation are cycloaliphatic (di)epoxies, such as 3,4-epoxycyclohexylmethyl-3′,4′-epoxycyclohexane carboxylate of formula (Ia):

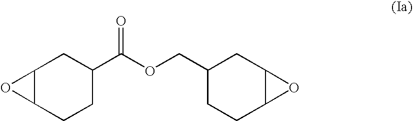

The ring strain in the epoxy group is further increased by the cyclohexane ring connected to it, strongly increasing the reactivity of the epoxy group compared to linear epoxy groups. Other epoxy types can also be initiated by onium salts, but with less reactivity. Sometimes these materials will not polymerise themselves, but only copolymerise with a more reactive species that is present.

Oxetanes have recently received a lot of attention, with several producers supplying and developing different types of oxetanes. Oxetanes are cyclic ethers that very efficiently polymerise with high reaction speeds. Oxetanes have a high diluting power and, when used in the right amounts, can have a strong positive effect on other properties, such as adhesion, chemical resistance, gas barrier and others. The most common oxetane used in UV cationic compositions is 3-ethyl-3-hydroxymethyloxetane (also known as trimethylolpropyl oxetane or TMPO), which has the formula (Ib):

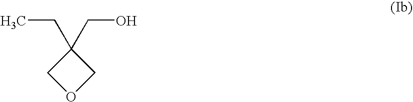

Other oxetanes, such as bis[(3-methyloxetan-3-yl)methyl]ether (also known as dioxetane or DOX), which has the formula (Ic):

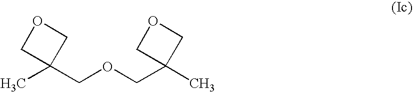

and others, are also commercially available.

It is less well known that there is another class of ultraviolet curable materials that can be initiated with the strong acid that forms after UV irradiation of a cationic photoinitiator. In 1978 3M described in U.S. Pat. No. 4,101,513 the photo-polymerisation of alkoxysilanes (XO)ₘSiR₄₋ₘ with onium salts, in which X is a hydrolysable group or hydrogen, R is a hydrocarbyl group and m is a number between 1 and 4. This patent did not, however, result in widespread commercial activities, even though there are many potential applications.

The mechanism of the photoinitiated polymerisation of alkoxysilanes starts with the formation of an acid with the anion of the onium salt as one of the products (HY) from the onium salt upon ultraviolet irradiation.

The proton from this acid will then be incorporated into an alkoxysilane precursor molecule (XOₘSiR₄₋ₘ), forming a cationic species [XOₘ₋₁(XOH⁺)SiR₄₋ₘ], which, in the presence of water, will react to [XOₘ₋₁(OH₂)⁺SiR₄₋ₘ] (hydrolysis), releasing XOH. This cationic species can react with other alkoxysilanes, releasing a water molecule and forming a silica bond between the alkoxides [(XO)ₘ₋₁(R₄₋ₘ)Si—O—Si(R₄₋ₘ)(XO)ₘ₋₁] and a proton that can initiate a new reaction. The reaction can then proceed until all alkoxide side-groups of the alkoxysilane precursors have reacted (disregarding steric and other hindrances) to form a three-dimensional silica network.

This type of UV curable curing of alkoxysilanes bears a strong resemblance to sol-gel reactions, where the curing of metal alkoxide precursors (such as alkoxysilanes) is catalyzed by an added dose of acid (or base) at elevated temperatures. Photoinitiated curing has the advantage that it is much faster and occurs at room temperature. Also, commercial sol-gel reactions are multi-pot systems, while UV-curable metal alkoxide compositions are a one-pot system. However, curing of thick layers or three-dimensional structures will be more difficult with photoinitiated curing.

Compared to other UV curable materials, UV curable alkoxysilanes result in hard, temperature and chemical resistant coatings. They can have a post-cure effect. However, shrinkage can be high, flexibility limited and, due to their generally low viscosity, application techniques and thick layers can prove difficult.

Hybrid coatings consisting of UV curable alkoxysilanes (or other metal alkoxides) with acrylic free radical UV curing materials have been and are still being investigated. In most cases an acrylic or methacrylic group is bonded to the alkoxysilane [e.g. (3-methacryloxypropyl)trimethoxysilane]. Usually, in these compositions, the alkoxysilanes are thermally cured, while the acrylic or methacrylic groups are cured with UV light.

This invention provides compositions which are a hybrid of a cyclic ether and an alkoxysilane and which can be cured by ultraviolet light to form a coherent coating. Compatibility between these materials and the necessary cationic photoinitiators is usually poor, but the present invention allows compatible, one-component compositions to be prepared which can be cured by ultraviolet light to form hard, coherent coatings.

The possibility of combining two types of UV cationic curable materials opens enlarged composition possibilities for both systems. Synergistic effects can result in enhanced viscosity control, reduced shrinkage and increased flexibility for alkoxysilane systems and increased hardness and viscosity reduction for cyclic ether systems.

The present invention is the result of intensive research and testing to achieve the desired compositions. It was found that hard, coherent coatings can be formed from an ultraviolet-curing resin composition that contains three essential components: (A) at least one silane having a hydrolysable group and at least one group containing a cyclic ether, (B) at least one material, which is not an alkoxysilane and is different from the silane (A), containing one or more cyclic ether groups, and (C) a cationic photoinitiator preferably of the onium type. The composition may also contain one or more of various optional components: (D) an organic solvent, preferably a cyclic carbonate solvent, (E) one or more alkoxysilanes which do not have a side group containing cyclic ethers and (F) particles, additives, co-reagents or co-solvents to influence performance properties, such as, but not limited to, flow, viscosity, reactivity, appearance, colour, adhesion, anti-corrosion, compatibility and/or defoaming agents.

The first essential component of the composition of the present invention is a silane (A) with at least one side group containing a cyclic ether. This is preferably a compound of formula (II):

XOₘSiR₍₄₋ₘ₎ (II)

in which: X represents a hydrolysable group; R represents a hydrocarbyl or hydrocarbyloxy group or such a group containing an oxygen, nitrogen or sulphur atom, and at least one group R includes a cyclic ether group; and m is a number between 1 and 4. More preferably, the compound of formula (II) is an alkoxysilane, in which XO represents an alkoxy group. Such compounds can be cured with a photoinitiated acid to form a three-dimensional silica network.

In the compounds of formula (II), XO represents a hydrolysable group, preferably an alkoxy group, and more preferably an alkoxy group having from 1 to 6 carbon atoms. Still more preferably, the alkoxy group is a linear group. Examples of suitable alkoxy groups which may be represented by XO include the methoxy, ethoxy, propoxy, isopropoxy, butoxy, isobutoxy, t-butoxy, pentyloxy and hexyloxy groups. Of these, the methoxy (CH₃O) or ethoxy (CH₃CH₂O) group is preferred, since longer alkoxides have very low reactivity for hydrolysis reactions. In general, methoxy-type alkoxysilanes are more reactive than ethoxy silanes.

Where there is more than one group R in the compound of formula (II), the different R groups do not have to be the same. They can be any combination possible, provided that at least one group contains a cyclic ether.

At least one group R should include a cyclic ether group, which is preferably an epoxy group or an oxetane group. Preferably, the epoxy group forms part of a glycidyloxy group. The cyclic ether group, e.g. the glycidyloxy group or other epoxy group, is preferably linked to the silicon atom by an alkyl or alkoxy group. This alkyl or alkoxy group preferably has from 1 to 6 carbon atoms, and examples include the methyl, ethyl, propyl, isopropyl, butyl, isobutyl, t-butyl, pentyl, hexyl, methoxy, ethoxy, propoxy, isopropoxy, butoxy, isobutoxy, t-butoxy, pentyloxy and hexyloxy groups, preferably the ethyl or propyl groups.

The other R groups can be any hydrocarbyl type group, from short chain alkyl groups, to longer, branched hydrocarbyl structures, cycloalkyl groups, aromatic groups, aminoalkyl groups, other alkyl-linked epoxide groups, alkyl-linked oxetane groups, ether groups, ester groups, isocyanate alkyl groups, linked anhydridic groups, vinyl groups, mercaptoalkyl groups (meth)acrylate groups or any other hydrocarbyl group. The R group can also be a linking group to a polymeric backbone or to other silane groups (for example in tris-[3-(trimethoxysilyl)propyl] isocyanurate).

The number m may be any number from 1 to 4, e.g. 1, 2, 3 or 4. Although it will be appreciated that, in any single molecule, the number must be an integer, in practice, unless the material used is a pure single compound, the number may be non-integral. We prefer that m should be about 3 (i.e. there should be an average of about 3 XO groups and about 1 R group per molecule).

Most preferably (ω-glycidoxyalkyl)-alkoxysilanes, such as (3-glycidoxypropyl)-alkoxysilanes or (2-glycidoxyethyl)-alkoxysilanes are used as the essential alkoxysilane (A), due to their widespread availability from various commercial suppliers at relatively low cost. Examples of suitable commercially available materials include (3-glycidoxypropyl)-trimethoxysilane (usually referred to as GLYMO), (2-glycidoxyethyl)-trimethoxysilane, (3-glycidoxypropyl)-triethoxysilane, (2-glycidoxyethyl)-triethoxysilane and 3-glycidoxy propyl 3-glycidoxypropyl methyldiethoxysilane.

For example, 3-glycidoxypropyl trimethoxysilane (GLYMO) has the formula (IIIa):

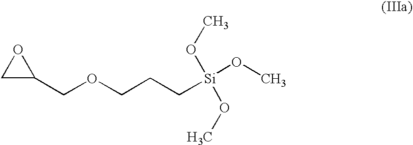

Furthermore, alkyl- or alkoxy-linked cycloaliphatic epoxy or oxetane groups may be used as the essential alkoxysilane (A), although these are less readily available and significantly more expensive then (3-glycidoxy propyl)-alkoxysilanes. In this case preferred compounds include [β- or ω-(3,4-epoxycyclohexyl)alkyl]trialkoxysilanes, for example [β-(3,4-epoxycyclohexyl)ethyl]triethoxysilane, which has the formula (IIIb):

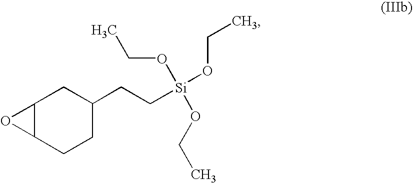

or a 3-alkyl-3-[(trialkoxysilylalkoxy)methyl]oxetane, such as 3-methyl-3-[(3-trimethoxysilylpropoxy)methyl]oxetane, which has the formula (IIIc):

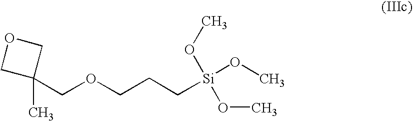

These compounds are commercially available.

At least 5% of the total composition should preferably be one or more alkoxysilanes having a cyclic ether-containing side group. More preferably at least 15% of the total composition should be such an alkoxysilane.

The second essential component of the composition of the present invention is a cationically ultraviolet-curable material, which is not an alkoxysilane, but which does contain one or more cyclic ether groups. This is component (B)

Cycloaliphatic diepoxides are the most common monomers used in UV cationic polymerisation. 3,4-Epoxycyclohexylmethyl-3′,4′-epoxycyclohexane carboxylate of formula (Ia) is available from various suppliers and is the base material in most UV cationic compositions. This is the preferred compound for use as component (B). Modified versions of this molecule are possible as well, such as acrylic functionalised versions, variations on the bridging chain and other variations and substitutions.

Monomers containing oxetane groups are becoming more popular, due to their lower viscosity and improved reactivity compared to cycloaliphatic diepoxides. Oxetanes are compatible with alkoxysilanes that contain cyclic ethers in one of their side groups, and so may also be used as component (B) of the composition of the present invention. Examples include 3-ethyl-3-hydroxymethyl-oxetane of formula (Ib), which is available from various suppliers. Other oxetanes, such as bis[(3-methyloxetan-3-yl)methyl]ether, which has the formula (Ic), and others, are available from selected suppliers as well.

The total composition should preferably contain at least one percent by weight of the total composition of cyclic ethers, but to have any effect, more preferably there should be at least 5 percent by weight present in the total composition. If compatibility allows, up to 90 percent by weight of the composition may consist of cyclic ethers.

The third essential component (C) of the composition of the present invention is a cationic photoinitiator. This is a material that upon UV irradiation dissociates into two or more components, one of which is a strong acid that can initiate the polymerisation of both the present alkoxysilanes and the cyclic ethers described above.

Most types of cationic photoinitiators are materials that undergo the desired dissociation when irradiated with UV light. These photoinitiators are usually the so-called onium salts (such as diazonium, iodonium and sulphonium salts). Also, metallocenium salts (such as ferrocenium salts) can be used. Onium salts generally have the structure: (R²)ₙA⁺(R¹)ₐY⁻, in which R¹ is an alkyl or alkenyl group, R² is an aromatic group at least as electron withdrawing as benzene, A is a Group Va, VIa or VIIa atom, n is a positive whole integer of at least two up to the valence of A plus one, a is zero or a positive whole integer up to valence of A minus one. n+a is equal to the valence of A plus one.

The materials mentioned above are positively charged with a value of +1. A negatively charged counterion is present. These are usually bonded fluorides, such as BF₄⁻, PF₆⁻, SbF₆⁻, AsF₆⁻, and others, because they are extremely weak bases, resulting in very strong or super-acids after dissociation of the onium group and which are extremely effective in initiating the desired polymerisation.

Iodonium and sulphonium salts are commercially available from various suppliers in different variations and these are the preferred onium salts to use as cationic photoinitiators for all cyclic ether containing components of the composition.

It might be necessary to use sensitizing molecules to enhance the sensitivity of the photoinitiator for the UV wavelengths emitted by the UV lamp. For common mercury lamps most sulphonium salts, such as Dow Cyracure UVI-6992, which has the formula (IVa) or IGM Omnicat-550, which has the formula (IVb), do not need sensitizers and are therefore the most preferred photoinitiators to use. Iodonium salts [such as Ciba Irgacure 250, which has the formula (IVc)] often need sensitizers with mercury lamps, such as isopropyl thioxanthone [ITX, which has the formula (IVd)], to be more effective.

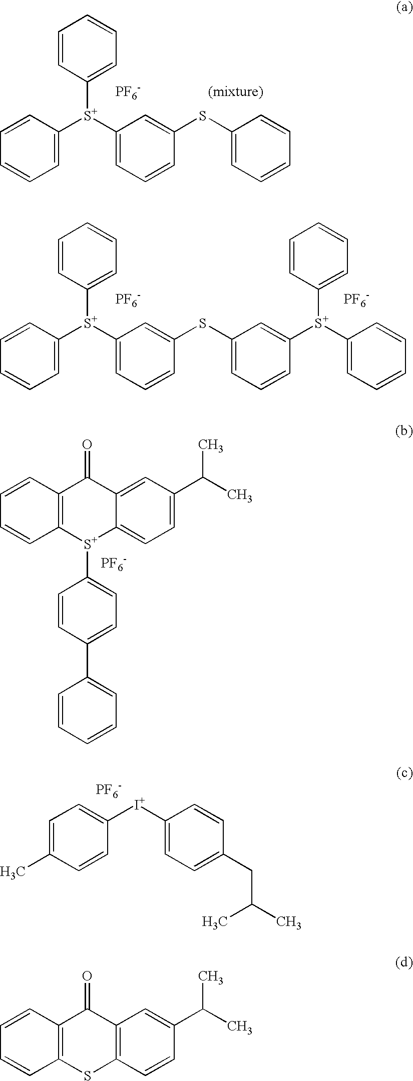

The composition may preferably contain up to 10 percent by weight of the total photoinitiator(s) plus sensitisers, if used. Compatibility will become problematic at higher amounts. More preferably, the photoinitiator should be between 0.5 and 5.0 percent by weight of the total composition.

The first optional component (D) of the composition is an organic solvent in order to enhance the compatibility of the photoinitiator with the alkoxysilanes. Also, because many solid cationic photoinitiators are toxic in their pure form, it is preferred to use the photoinitiator in a dissolved state.

Alcohols, such as ethanol and isopropanol, or alkyl acetates, such as ethyl acetate or butyl acetate, are possible organic solvents, but the best results are obtained when cyclic carbonates are used. Propylene carbonate, which has the formula (V):

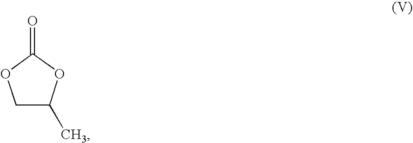

shows good compatibility with the complete-system, particularly when the initiator:solvent weight ratio is between 1:3 and 1:8, depending on the complete composition. In WO06093678A1 and WO06093679A1 it was disclosed that certain propylene carbonate ratios have an advantageous effect on the reactivity and properties of regular UV cationic systems and that the propylene carbonate is built into the polymeric network (strongly reducing solvent evaporation).

Other alkoxysilanes (with no side groups containing cyclic ethers), preferably of the structure XOₘSiR₄₋ₘ, may be added as an optional component (E) to the composition as co-reagents. Some examples of common commercially available alkoxysilanes are tetraethoxysilane (TEOS, X is CH₃CH₂, m=4), tetramethoxysilane (TMOS, X is CH₃, m=4), methyltriethoxysilane (MTES, X is CH₃CH₂, m=3, R is CH₃), methyltrimethoxysilane (MTMS, X is CH₃, m=3, R is CH₃), dimethyldimethoxysilane (DMDMS, X is CH₃, m=2, R is CH₃), ethyltriethoxysilane (ETES, X is CH₂CH₃, m=3, R is CH₂CH₃), phenyltriethoxysilane (PTES, X is CH₂CH₃, m=3, R is C₆H₅), vinyltriethoxysilane (VTES, X is CH₃CH₂, m=3, R is CH═CH₂), vinyl trimethoxysilane (VTMS, X is CH₃, m=3, R is CH═CH₂), and alkoxysilanes that are side groups or end groups of other materials, such as polymeric backbones or isocyanurate groups. Versions in which there are differing R-groups on one molecule are also possible, as are all variations on these structures common to this field.

The amount of all alkoxysilanes present, including those with cyclic ether containing side groups, may range from 10 to 90 percentage of the total weight. The ratio of the various alkoxysilanes components is without limitations, although it is highly preferred that the alkoxysilane with cyclic ether containing side groups component should make up at least 5% of the total composition weight.

Other optional co-reagents may be materials that are not very reactive or do not polymerise at all with cationic photoinitiators, but that do co-polymerise with cycloaliphatic epoxides or oxetanes. Polyols (monomers with multiple available hydroxyl groups) are the most common copolymerising species (including dendritic polyols), but other materials, such as vinyl ethers, may be used as well.

All these standard UV cationic materials can be mixed with the alkoxysilanes with cyclic ether containing side groups, initiators and cyclic carbonates. Compatibility is good to excellent and this opens up new composition possibilities above those of UV cationic curing of both alkoxysilanes as well as more commonly known UV cationic curable materials.

Cationic curing of alkoxysilanes and cyclic ethers usually have a post-cure (or dark-cure), where the polymerisation reaction continues after the UV irradiation has been switched off. This post-cure is advantageous to reach good conversion in thick layers, shadowed, curved or bent areas, but might be disadvantageous when the coating is not immediately dry and it takes some time before the final properties are reached. The post-cure can be sped up when the coating is heated directly after or during UV irradiation (e.g. to 70° C.).

A non-limited amount of other optional components in the composition of the present invention can be particles, additives, co-reagents or co-solvents to influence performance properties. These additional materials can be used to control or improve properties, such as flow, viscosity and rheology, appearance, colour, compatibility, reactivity, adhesion, anti-corrosion and/or defoaming and others.

### EXAMPLE 1

### Comparative

Three non-hybrid compositions were prepared by mixing the components described below using conventional mixing techniques.

REF1 is a UV Sol-Gel composition containing 4 percent by weight of sulphonium type photo-initiator Cyracure UVI-6992 (Dow Chemicals, 50% photo-initiator in propylene carbonate), 11.94 percent by weight propylene carbonate, 21 percent by weight (3-glycidoxypropyl)trimethoxysilane (GLYMO, Wacker Chemie), 63 percent by weight methyltrimethoxysilane (MTMS, Degussa) and 0.06 percent by weight flow additive Byk-333 (Byk Chemie). REF2 is a cationic UV curable composition containing 4 percent by weight Cyracure UVI-6992, 95.94 percent by weight cycloaliphatic epoxy Uvacure 1500 (3,4-epoxycyclohexylmethyl-3′,4′-epoxycyclohexane carboxylate, Cytec) and 0.06 percent by weight Byk-333. REF3 is a cationic UV curable composition containing propylene carbonate as a co-reacting solvent. This composition contains 4 percent by weight Cyracure UVI-6992, 11.94 percent by weight propylene carbonate, 84 percent by weight cycloaliphatic epoxy Uvacure 1500 (Cytec) and 0.06 percent by weight Byk-333.

Of these compositions various physical properties were measured: the viscosity (DIN 53019), open time (time to achieve a “finger-dry” coating after one pass under the UV lamp (H-bulb, 1.2 J/cm², band speed 5 m/min), indentation hardness (measured after 24 hours, U; PHV 623-93/487 (Philips Electronics test standard)), adhesion to plastic (acrylonitrile butadiene styrene, ABS) and glass (measured after 24 hours, cross-hatch tape test, DIN 53151), pencil hardness (measured after 24 hours, substrate is glass) (ASTM D-3363) and shrinkage (internal method: a narrow cuvet with known volume was filled with the composition and cured for several days. The volume decrease was then determined by measuring the weight of a liquid of known density added to the cuvet that fills the volume created by the shrinkage. This is only an indicative method, the actual value of the shrinkage is tentative and should only be used in comparative experiments between compositions).

The viscosity of cationic UV compositions REF2 and REF3 were significantly higher than UV Sol-Gel composition REF 1. The open time of REF1 was 0 seconds, which means that the composition is immediately dry to the touch and can be handled after 1 pass under the UV lamp, while REF2 and REF3 had an open time of more than a minute. Also, the indentation hardness, pencil hardness and adhesion to glass were significantly better for REF1 compared to both REF2 and REF3. On the other hand, the shrinkage of the UV Sol-Gel composition REF1 was very high, while that of cationic UV curable compositions REF2 and REF3 was very low.

### EXAMPLE 2

### Cycloaliphatic Epoxide

In this series of experiments, the amount of cycloaliphatic epoxy was varied. All compositions contained 4 percent by weight Cyracure UVI-6992, 11.94 percent by weight propylene carbonate, 21 percent by weight GLYMO and 0.06 percent by weight Byk-333, as well as MTMS and a standard cycloaliphatic epoxy, Uvacure 1500. In compositions CAE1 to CAE3 Uvacure 1500 was added to the composition at the expense of MTMS. CAE1 contained 10 percent by weight Uvacure 1500 and 53 percent by weight MTMS, CAE2 contained 20 percent by weight Uvacure 1500 and 43 percent by weight MTMS and CAE3 contained 30 percent by weight Uvacure 1500 and 33 percent by weight MTMS.

Of these compositions the viscosity, open time, indentation hardness, adhesion to ABS and glass, pencil hardness (substrate is glass) and shrinkage were measured.

The viscosity was strongly reduced when compared with cationic UV curable compositions REF2 and REF3. At an amount of 30 percent by weight cycloaliphatic epoxy (CAE3) the viscosity began to rise compared with UV Sol-Gel formulation REF1. The open time was 0 seconds for all hybrid systems, a vast improvement on cationic UV curable compositions REF2 and REF3. The coating was dry to the touch after 1 pass under the lamp. However, post-cure did occur and final properties were obtained after some time. The indentation hardness deteriorated with increasing amounts of cycloaliphatic epoxy. The adhesion to glass was similar to that of UV Sol-Gel composition REF1, again an improvement compared to REF2 and REF3. The pencil hardness deteriorated at cycloaliphatic epoxy amounts greater than 10 percent by weight. The shrinkage of CAE1, CAE2 and CAE3 was significantly reduced compared to UV Sol-Gel composition REF1, but a slight increase compared to cationic UV curable formulations REF2 and REF3.

### EXAMPLE 3

### Oxetanes

In this series of experiments, oxetanes were added to the UV Sol-Gel system. All compositions contained 4 percent by weight Cyracure UVI-6992, 11.94 percent by weight propylene carbonate, 21 percent by weight GLYMO, 53 21 percent by weight MTMS and 0.06 percent by weight Byk-333, as well as 10 percent by weight oxetane. The oxetane in composition OX1 was mono-oxetane TMPO (3-Ethyl-3-hydroxymethyl-oxetane, Perstorp). The oxetane in composition OX2 was di-oxetane OXT-221 (Bis {[1-ethyl(3-oxetanil)]methyl}ether, ToaGosei).

Of these compositions the viscosity, open time, indentation hardness, adhesion to ABS and glass, pencil hardness (substrate is glass) and shrinkage were measured.

The viscosity was low for all cationic UV curable materials, similar to UV Sol-Gel composition REF1. The open time was 0 seconds. The indentation hardness was worse than that of REF1, but slightly better (OX2) or comparable (OX1) to CAE1. Adhesion to glass and pencil hardness were good, comparable to REF1 and CAE1. The shrinkage of both oxetane containing compositions OX1 and OX2 was significantly reduced compared to UV Sol-Gel composition REF1.

The results of all the above Examples, together with a summary of the compositions, are shown in the following Table 1.

TABLE 1
Example Formulations And Properties.

| | Example 1 | | | Example 2 | | | Example 3 | |
|---|---|---|---|---|---|---|---|---|
| | REF1 | REF2 | REF3 | CAE1 | CAE2 | CAE3 | OX1 | OX2 |
| Cyracure UVI-6992 | 4 | 4 | 4 | 4 | 4 | 4 | 4 | 4 |
| (grams) | | | | | | | | |
| Propylene Carbonate | 11.94 | | 11.94 | 11.94 | 11.94 | 11.94 | 11.94 | 11.94 |
| (grams) | | | | | | | | |
| GLYMO (grams) | 21 | | | 21 | 21 | 21 | 21 | 21 |
| MTMS (grams) | 63 | | | 53 | 43 | 33 | 53 | 53 |
| Byk-333 (grams) | 0.06 | 0.06 | 0.06 | 0.06 | 0.06 | 0.06 | 0.06 | 0.06 |
| Uvacure 1500 (grams) | | 95.94 | 84 | 10 | 20 | 30 | | |
| TMPO (grams) | | | | | | | 10 | |
| OXT-221 (grams) | | | | | | | | 10 |
| Clear solution | Yes | Yes | Yes | Yes | Yes | Yes | Yes | Yes |
| (compatible system) | | | | | | | | |
| Viscosity (mPas) | 5 | 196 | 80.5 | 5 | 5 | 6 | 5 | 5 |
| Open Time (s) | 0 | 170 | 75 | 0 | 0 | 0 | 0 | 0 |
| Indentation Hardness | 0.9 | 2.4 | 1.7 | 1.9 | 3.8 | 4.0 | 1.9 | 1.6 |
| (24 hrs, μm) | | | | | | | | |
| Adhesion to ABS plastic | Gt0 | Gt3 | Gt0 | Gt0 | Gt0 | Gt0 | Gt0 | Gt0 |
| Adhesion to glass | Gt0 | Gt3 | Gt5 | Gt0 | Gt0 | Gt0 | Gt0 | Gt0 |
| Pencil Hardness (on glass) | 7H | B | 4H | 7H | F | F | 7H | 7H |
| Shrinkage (%) | 30 | 5 | 5 | 10 | 10 | 10 | 10 | 10 |

1. An ultraviolet-curable resin composition comprising: (A) at least one silane having a hydrolysable group and at least one gylcidyloxyalkyl group; (B) at least one material containing one or more cycloaliphatic epoxy groups, which is not an alkoxysilane and is different from the silane (A); and (C) a cationic photoinitiator.

2. A composition according to claim 1, in which the silane (A) is a compound of formula (II):
XOₘSiR₍₄₋ₘ₎ (II)
in which: XO represents a hydrolysable group; each R independently represents a hydrocarbyl or hydrocarbyloxy group or such a group containing an oxygen, nitrogen or sulphur atom, and at least one group R includes a gylcidyloxyalkyl group; and m is a number between 1 and 4.

3. A composition according to claim 2, in which the compound of formula (II) is an alkoxysilane, in which XO represents an alkoxy group.

4-6. (canceled)

7. A composition according to claim 3, in which R represents a 3-glycidyloxypropyl group.

8-10. (canceled)

11. A composition according to claim 1, in which said silane (A) is an ω-glycidoxyalkyl)-alkoxysilane.

12. A composition according to claim 1, in which said silane (A) is a (3-glycidoxypropyl)-alkoxysilane or (2-glycidoxyethyl)-alkoxysilane.

13. A composition according to claim 1, in which said silane (A) is (3-glycidoxypropyl)-trimethoxysilane, (2-glycidoxyethyl)-trimethoxysilane, (3-glycidoxypropyl)-triethoxysilane, (2-glycidoxyethyl)-triethoxysilane or 3-glycidoxy propyl 3-glycidoxypropyl methyldiethoxysilane.

14. A composition according to claim 1, in which the material (B) is a cycloaliphatic epoxy.

15. A composition according to claim 1, in which the cationic photoinitiator (C) is of the onium type.

16. A composition according to claim 15, in which the cationic photoinitiator is a sulphonium or iodonium compound.

17. A composition according to claim 1, additionally comprising an organic solvent.

18. A composition according to claim 17, in which the organic solvent is propylene carbonate.

19. A process in which a composition according to claim 1 is cured by exposure to ultraviolet radiation.

20. An article coated with a cured composition produced by curing a composition according to claim 1.

21. A composition according to claim 14, in which material (B) is 3,4-diepoxycyclohexane carboxylate or a modified version thereof.

22. A composition according to claim 2, in which R represents a 3-glycidyloxypropyl group.

23. A composition according to claim 1, in which said silane (A) is present in an amount of at least 5% by weight of the total composition.

24. A composition according to claim 1, in which said material (B) is present in an amount of at least 5% by weight and up to 90% by weight of the total composition.

25. A composition according to claim 24, in which said silane (A) is present in an amount of at least 15% by weight of the total composition.

26. A composition according to claim 1, in which said silane (A) is present in an amount of at least 15% by weight of the total composition.
